(19) United States
(12) Patent Application Publication
(10) Pub. No.: US 2023/0210044 A1
(43) Pub. Date: Jul. 6, 2023

(54) PISTON DEVICE FOR LOADING MATERIAL INTO A TUBE

(71) Applicant: Thomas Allen Kittle, II, Glenwood, IA (US)

(72) Inventor: Thomas Allen Kittle, II, Glenwood, IA (US)

(21) Appl. No.: 18/162,589

(22) Filed: Jan. 31, 2023

Related U.S. Application Data
(63) Continuation-in-part of application No. 16/946,704, filed on Jul. 1, 2020, now Pat. No. 11,571,016.
(60) Provisional application No. 62/871,010, filed on Jul. 5, 2019.

(51) Int. Cl. A01C 23/02

(52) U.S. Cl. CPC A01C 23/027; A24C 5/42

(57) ABSTRACT

A piston device is disclosed as it may have a cylinder and a piston. In an example, the cylinder has a first end and a second end. The piston is configured to be pushed into the second end of the cylinder in an inserted configuration and withdrawn from the second end of the cylinder in an extended configuration. The piston is slidable between the inserted configuration and the extended configuration during operation. Material is received into the cylinder through an opening in the first end of the cylinder without a vacuum, and pressing the piston into the second end of the cylinder compresses the material within the cylinder, and then releases the material from the cylinder.

### PRIORITY CLAIM

This application claims priority as a continuation-in-part (CIP) of U.S. patent application Ser. No. 16/946,704 filed Jul. 1, 2020 titled “Piston Device For Loading Smoking Material Into A Tube” of Thomas Allen Kittle II, which claims the priority benefit of U.S. Provisional Patent Application No. 62/871,010 filed Jul. 5, 2019 titled “Piston Device For Loading Smoking Material Into A Tube” of Thomas Allen Kittle II, each hereby incorporated by reference in its entirety as though fully set forth herein.

### BACKGROUND

The art of rolling cigarettes has been around for a long time. This typically involves taking a smoking material and laying it on a paper, and then rolling the paper around the smoking material. The paper may have an adhesive to fasten the two ends together and form a tube around the smoking material, referred to as a cigarette. Preformed tubes are also available, in which the smoking material can simply be added (e.g., usually by scooping and/or pouring it from a tray or other instrument into the tube). However, none of these methods provide for an efficient and clean way to make cigarettes (joints, cigars, etc.).

### BRIEF DESCRIPTION OF THE DRAWINGS

FIG. 1 is a perspective view of an example piston device for loading smoking material into a tube.

FIG. 2 shows components of the example piston device for loading smoking material into a tube.

FIG. 3 is a close-up perspective view at a second end of the cylinder with a cap of the example piston device for loading smoking material into a tube.

FIG. 4 is a close-up perspective view of a piston of the example piston device for loading smoking material into a tube.

FIGS. 5A-C illustrate operations of the example piston device for loading smoking material into a tube.

FIG. 6 is a perspective view of another example piston device in a closed position.

FIG. 7 is a perspective view of the example piston device shown in FIG. 6 in an open position.

FIG. 8 is a perspective view of another example piston device in both a packaged configuration and with the piston removed from the packaging.

FIG. 9 illustrates example operation of the piston device shown in FIG. 8.

### DETAILED DESCRIPTION

A piston device is disclosed for the clean collection and loading of a material (e.g., pollen and/or fine plant particularly suitable for smoking) into various shapes and sizes of paper and/or other tubes (e.g., for smoking). The piston device is described herein for purposes of illustration as it may be implemented for loading smoking material into a tube to make cigarettes, joints, cigars, etc. for smoking. It is noted, however, that the device may be implemented for other purposes as well, such as but not limited to, loading a material into storage tubes and/or for other industries besides the smoking industry (e.g., gardening or plant care).

An example of the device for loading smoking material into a tube includes a cylinder and a piston. The cylinder includes a handle and flexible shaft with an internal diameter slightly greater than the outer diameter of the piston. The piston, which may be solid, has an outer diameter slightly less than the inner diameter of the cylinder. One end of the cylinder may be flexible (e.g., to enhance picking up the smoking material), and the other end of the cylinder may be hard and thick to allow for compression of plant material within the cylinder.

The cylinder serves as both a collection chamber, and a compression chamber for the smoking material. That is, the piston and cylinder can be implemented to pick up smoking material in the cylinder. The piston can then be pressed into the cylinder to compress the smoking material within the cylinder before discharging the smoking material into the smoking tube. In an example, a cap is provided over the open end of the cylinder after receiving the smoking material so that the smoking material can be pressed against the cap inside of the cylinder without needing to place the cylinder against a separate surface or tool during compression.

In an example, the device has a smooth bore shaft and piston. The piston is not attached to the cylinder. That is, the piston can be removed from one end of the cylinder and reinserted from the opposite side. The piston may be operated to compress the smoking material within the cylinder, and discharge the compressed smoking material into a tube.

In an example, the piston has a wider end or flange to form a surface to pull the piston. The smoking material is received in the cylinder, and then the piston is operated to press against (e.g., by hand) to compress and/or discharge the smoking material from the cylinder into the tube to form the cigarettes, joints, cigars, etc. for smoking.

In an example, the handle is designed to be thick, not only for providing a better grip, but also for strength and durability (e.g., during compression of the smoking material).

In an example, the collection tip (straw) of the cylinder may be flexible so that the tip can be pressed into corners of grinders, against the edge of trays, etc. to enhance collection of the smoking material in the cylinder without leaving much, if any, behind.

In an example, the device also includes a cap that can be closed over the cylinder end once the smoking material has been received in the cylinder. The cap provides a surface on which to compress the smoking material against within the cylinder, while also giving more strength to the handle.

Although the device can be implemented to load smoking material into cigarette papers and other smoking implements, the device may also be implemented for any number of other end-uses. Other examples include, but are not limited to, transferring pollen and fine plant material to/from storage containers and other vessels.

Before continuing, it is noted that as used herein, the terms “includes” and “including” mean, but is not limited to, “includes” or “including” and “includes at least” or “including at least.” The term “based on” means “based on” and “based at least in part on.”

It is also noted that the examples shown and described are provided for purposes of illustration, and are not intended to be limiting. Other devices and/or device configurations may be utilized, as will be readily apparent to those having ordinary skill in the art after becoming familiar with the teachings herein.

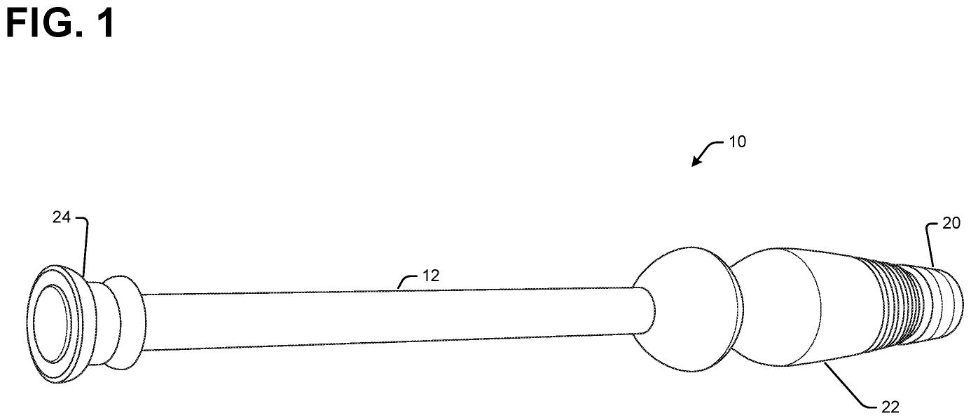

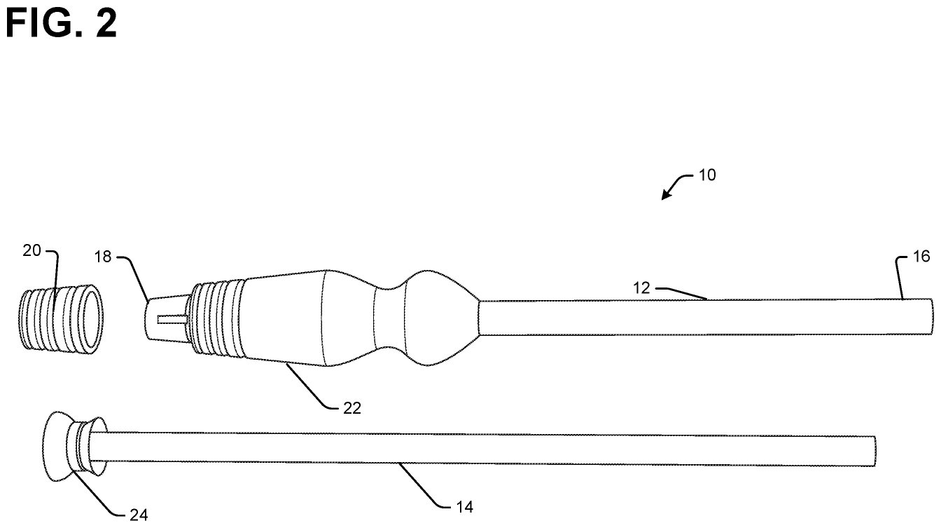

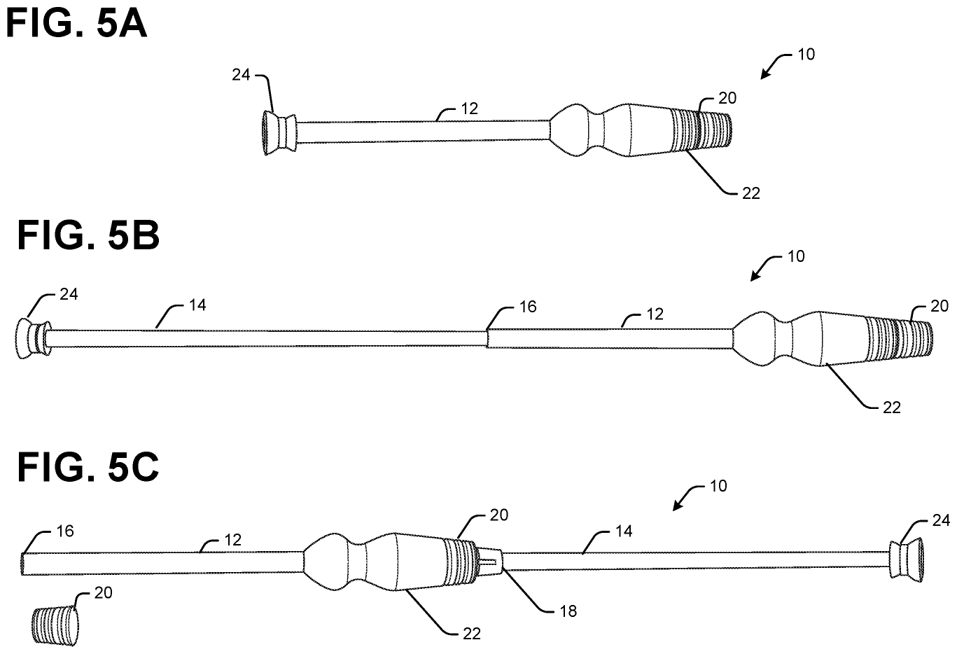

FIG. 1 is a perspective view of an example piston device 10 for loading smoking material into a tube (not shown). FIG. 2 shows components of the example piston device 10 for loading smoking material into a tube. An example piston device 10 for loading smoking material into a tube includes a cylinder 12 and a plunger or piston 14. The piston 14 is configured to be positioned within the cylinder 12 in a stored configuration (e.g., as shown in FIG. 1 and FIG. 5A). The piston can be removed from a first end 16 of the cylinder when in the stored configuration, and then inserted into a second end 18 of the cylinder 12 for use in an operating configuration (e.g., as shown in FIG. 5C).

In an example, the cylinder 12 has an internal diameter which is larger than the outer diameter of the piston 14. In an example, one end of the cylinder 12 is hard and thick to form a handle portion 22. The smoking material may be compressed within the cylinder 12, e.g., by assembling the cap 20 and then pressing the piston 14 against the smoking material after it has been received in the cylinder 12, toward the end of the cylinder 12 having the cap 20.

In an example, a portion of the cylinder 12 (e.g., a tip portion toward the first end 16) is flexible to enable gathering smoking material (e.g., from the corners of a tray). The cylinder 12 may have a smooth bore shaft.

The solid piston 14 may be withdrawn from the second end 18 of the cylinder 12 when in the operating configuration. The smoking material is received in a chamber formed within the hollow cylinder 12 through an opening in the first end 16 of the cylinder 12. Optionally, a cap 20 may be positioned over the first end 16 of the cylinder 12 to compress the smoking material within the chamber of the cylinder 12 against the cap 20. After the smoking material is compressed, the cap 20 may be removed to discharge the smoking material from the chamber of the hollow cylinder 12.

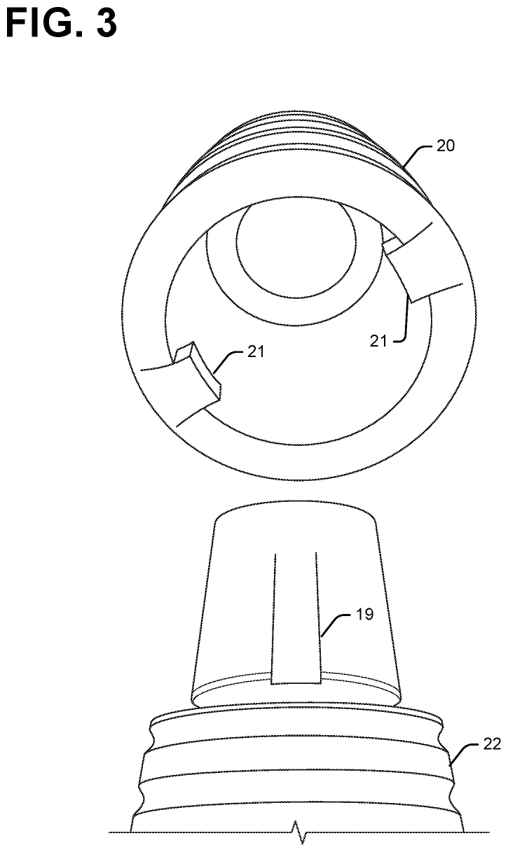

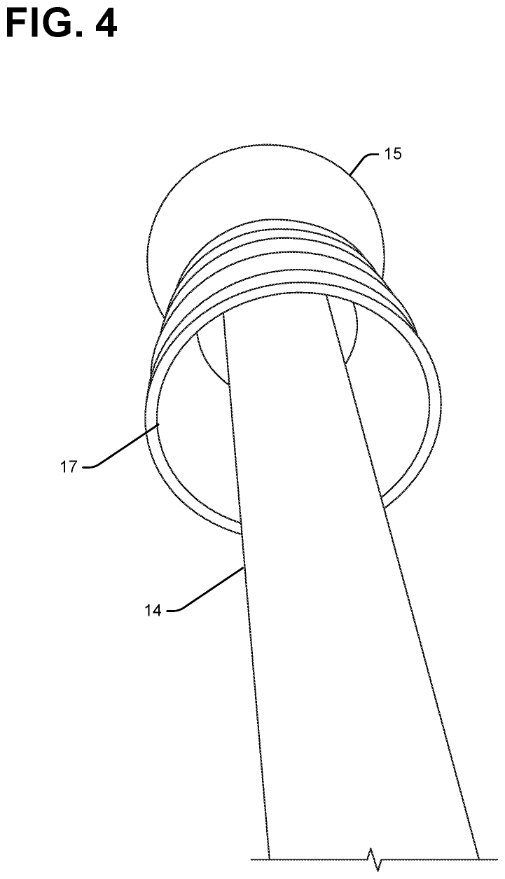

FIG. 3 is a close-up perspective view at second end 20 of the cylinder 12 with cap 20 of the example piston device 10 for loading smoking material into a tube. FIG. 4 is a close-up perspective view of piston 14 of the example piston device 10 for loading smoking material into a tube.

In an example, the cap 20 for the second end 18 of the cylinder 12 slip locks onto the second end 18 of the cylinder 12. That is, notches 19 on opposite sides of the handle 22 receive a mating engagement 21 on the inside of the cap 20. As such, the cap 20 can slide onto the end of the handle 22. The cap 20 can then be rotated so that the mating engagement 21 does not line up with the notches 19, thereby locking the cap 20 onto the handle 22.

The cap 20 is not limited to such a design. In other examples, the cap 20 may press-fit or threadably engage with the handle 22. Other attachment mechanisms will also be applicable, as would be well understood by those having ordinary skill in the art after becoming familiar with the teachings herein.

In an example, the cap 20 provides several functions. The cap 20 closes the second 18 when not in use (e.g., when in a closed configuration). The cap 20 also can be attached to the first end 16 after plant material has been received in the cylinder 12. This provides a surface for the user to press the piston 14 against to compress the smoking material in the cylinder 14. The cap 20 may also provide additional strength for the handle of the cylinder 12.

In an example, the piston 14 is solid. The end 15 of the piston 14 may be solid (e.g., as shown in FIG. 1) or may be at least partially hollow 17 (as shown in FIG. 4). A hollow 17 portion of the piston 14 enables the end 15 to fit over the piston 14 and may also serve to secure the piston to the cylinder 12. The piston 14 has an outer diameter which is less than the inner diameter of the cylinder 12. The piston 14 has a wider end or flange 24 to aid in pressing the piston 14 through the cylinder 12.

FIGS. 5A-C illustrate operations of the example piston device 10 for loading smoking material into a tube. During operation, the piston 14 is pulled out of the cylinder 12 when in the operating configuration to receive smoking material into the cylinder 12 through the first end 16. The cap 20 may be assembled and then the piston 14 pressed back against the smoking material, to compress the smoking material within the cylinder 12.

By way of illustration, the solid piston 14 may be withdrawn from the second end 18 of the cylinder 12 when in the operating configuration. The smoking material is received in a chamber formed within the hollow cylinder 12 through an opening in the first end 16 of the cylinder 12. Optionally, the cap 20 may be positioned over (e.g., held, screwed onto, press-fit onto, etc.) the first end 16 of the cylinder 12 (or the first end 16 may be otherwise closed, even if by a finger of the operator). Then pressing the piston 14 into the second end 18 of the cylinder 12 compresses the smoking material within the chamber of the cylinder 12 against the cap 20. After the smoking material is compressed, the cap 20 may be removed from the first end 16 of the cylinder 12. In FIG. 5C, the cap 20 is shown adjacent to the end 16 of the cylinder 12 as it may have just been removed from the end 16. Then pressing the piston 14 into the cylinder 12 releases the smoking material from the chamber of the hollow cylinder 12 and into the smoking implement (e.g., a tube held or fastened at the first end 16 of the cylinder 12).

This process of receiving smoking material and compressing it may be repeated until the desired amount of smoking material has been gathered and compressed. The cap 20 may then be removed, and the piston 14 pressed back into the second end of the cylinder to release the smoking material from the cylinder 12 and into a tube, other smoking implement, or elsewhere (e.g., even back onto a tray).

The operations shown and described herein are provided to illustrate example implementations. It is noted that the operations are not limited to the ordering shown. Still other operations may also be implemented.

The ends of the cylinder 14 are described as first and second end herein for reference in an operating example, and are not intended to be limiting. In addition, other examples are also contemplated wherein the piston 14 and cap 20 may be provided on either end of the cylinder 20 to accomplish the loading and compressing of smoking material, prior to discharging it.

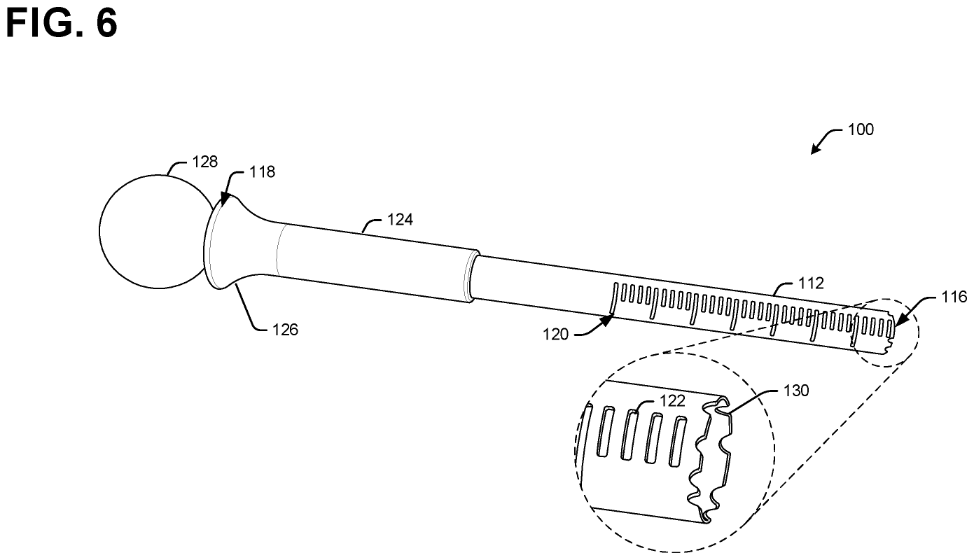

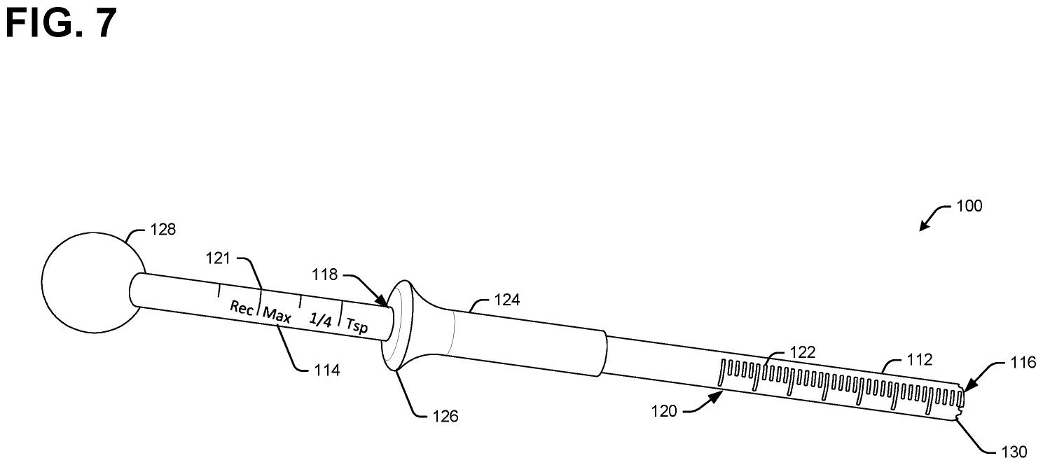

FIG. 6 is a perspective view of another example piston device 100 shown in a closed or retracted position. In the closed or retracted position, a plunger or piston 114 is at least partly pressed into a cylinder 112. FIG. 7 is a perspective view of the example piston device 100 of FIG. 6 shown in an open or extended position. In the open or extended position, the plunger or piston 114 is at least partly pulled out of the cylinder 112.

An example of the piston device 100, the cylinder 112 has a first end 116 and a second end 118. The piston 114 is configured to be pushed into the second end 116 of the cylinder 112 in an inserted configuration, and withdrawn from the second end 116 of the cylinder 112 in an extended configuration. The piston 114 is slidable between the inserted configuration and the extended configuration during operation, as shown between FIG. 6 and FIG. 7.

The piston 114 may be withdrawn from the cylinder 112. Material is received in the cylinder 112 through an opening in the first end 116 of the cylinder 112. In an example, the material is received into the cylinder without forming a vacuum. That is, the collection straw portion of the cylinder is pressed into the material to collect the material by compaction therein. Pressing the piston 114 into the second end 118 of the cylinder 112 may further compress the material within the cylinder 112 (e.g., when capped or held over a surface to close the first end 116) and/or releases the material from the cylinder 112.

In an example, the material is a gardening material, and the compressed gardening material is released from the cylinder near a plant. The material may be a plant fertilizer to be released after plunging the scalloped end into the soil to reach the roots of the plant in the soil. The graduated markings indicate to the user how deep the plunge is into the soil.

In an example, the piston device 100 includes graduated markings 120 on an outside of the cylinder 112 and/or graduated markings 121 on an outside of the piston 114. The graduated markings 120, 121 may indicate an amount or volume of the material collected and/or the depth that the cylinder is plunged into the soil for correct dosing and/or managing the collection volume. The graduated markings 120, 121 may include additional markings, such as number to indicate a volume or other amount and/or an indication or warning (e.g., MIN for minimum, MAX for maximum, REC MAX for recommended maximum dosage, etc.). In an example, the graduated markings 120, 121 are marked on the outside surface of the cylinder 112 and/or piston 114 (e.g, by painting). In another example, the graduated markings are indentations formed on the cylinder.

In an example, cutouts or windows 122 are formed through the outside wall of the cylinder 112 so that the user can see the material inside the cylinder 112. The windows 122 may also serve as graduated markings by themselves or in addition to other markings or indentations on the cylinder 112.

In an example, the piston 114 is solid and the cylinder 112 has a hollow interior. The cylinder 112 has a smooth bore shaft. The cylinder 112 may have a scalloped edge 130 to aid in digging the cylinder 112 into the material and/or to help poke or cut (e.g., by twisting) into soil and roots for direct root fertilizing. It can thus be pushed into the ground to release powder fertilizer at the roots.

In an example, the cylinder 112 has an internal diameter which is larger than the outer diameter of the piston 114. The piston 114 has an outer diameter which is less than the inner diameter of the cylinder 112.

In an example, the piston device 100 includes a wooden handle portion 124 mounted on the cylinder 112. The cylinder 112 may be made of metal. The wooden handle portion 124 is substantially cylindrical and has a splayed or flared end portion 126. The piston 118 is a substantially solid wooden cylinder (see FIG. 7) and has a wooden ball 128 formed on an end of the piston 118.

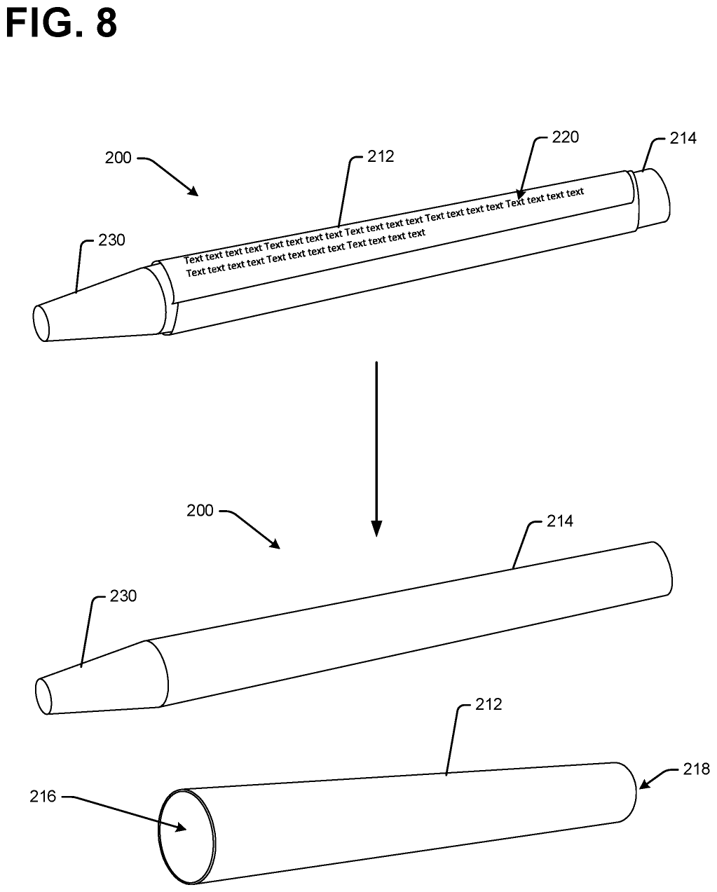

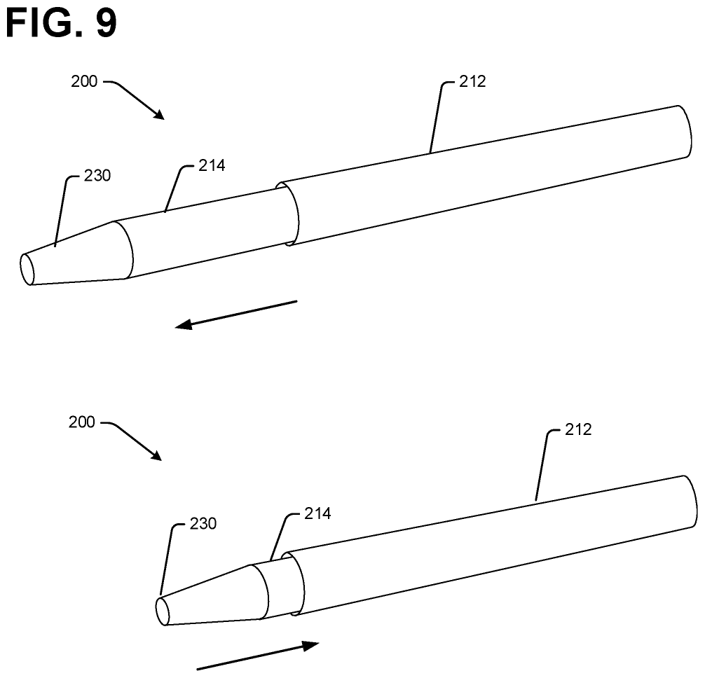

FIG. 8 is a perspective view of another example piston device 200. The piston device 200 is shown in FIG. 8 in a packaged configuration with the piston 214 in the packaging cylinder 212 (shown at top). The piston device 200 is also shown in FIG. 8 with the piston 214 removed from the packaging cylinder 212 (shown at bottom). FIG. 9 illustrates example operation of the piston device 200 shown in FIG. 8.

In an example, the piston device 200 includes a packaging cylinder 212 made of packaging material. The packaging cylinder 200 may be made of any suitable material, such as but not limited to paper, cardboard, plastic, coated paper, etc. such may be used in packaging and/or for printed instructions 220, drawings, logos, or other writing. The packaging may be flat and rolled or wrapped around the cylinder 212, or may be pre-formed in a cylindrical shape. In an example, the packaging may be taped or simply held by the user to form the cylindrical shape. The cylinder 200 has a first end 216 and a second end 218.

The piston device 200 also includes a piston 214 with a conical shaped head 230. In an example, the piston is made of wood. The piston 214 is configured to be pushed into the second end 218 of the cylinder 212 in an inserted configuration, and withdrawn from the second end 218 of the cylinder 212 in an extended configuration. The piston 214 is slidable between the inserted configuration and the extended configuration during operation, as shown in FIG. 9. The piston 214 may be withdrawn from the cylinder 212. Material is received in the cylinder 212 through an opening in the first end 216 of the cylinder 212. Pressing the piston 214 into the second end 218 of the cylinder 212 compresses the material within the cylinder when the first end 216 is covered or placed against a table or other surface. Pressing the piston 214 also releases the material from the first end 216 of cylinder 212.

In an example, the piston 214 has an outer diameter which is less than the inner diameter of the cylinder 212. The piston 214 may be solid and the cylinder 214 may be formed (e.g., by an end user) to have a hollow interior.

It is noted that the examples shown and described are provided for purposes of illustration and are not intended to be limiting. Still other examples are also contemplated.

1. A piston device, comprising:
a cylinder having a first end and a second end forming a collection straw for a plant fertilizer; and
a piston configured to be pushed into the second end of the cylinder in an inserted configuration and withdrawn from the second end of the cylinder in an extended configuration, the piston slidable between the inserted configuration and the extended configuration during operation;
an opening in the first end of the cylinder through which the plant fertilizer is received into the cylinder as the cylinder is pressed into the plant fertilizer, without creating a vacuum or suction to draw in the plant fertilizer, wherein pressing the piston into the second end of the cylinder while the cylinder is against an outside surface further compresses the plant fertilizer within the cylinder, and then releases the plant fertilizer from the cylinder;
a scalloped edge on the first end of the cylinder to aid in digging the cylinder into soil to release the plant fertilizer at or near plant roots.

2. The piston device of claim 1, further comprising graduated markings on the cylinder to indicate a depth of the collection straw in the plant fertilizer during collection of the plant fertilizer, and to further indicate a depth of the cylinder in the soil during release of the plant fertilizer.

3. The piston device of claim 1, further comprising graduated markings on the piston to indicate an amount of plant fertilizer collected in the collection straw.

4. The piston device of claim 1, further comprising a plurality of individual windows formed through an outside wall of the collection straw so that a user can see the plant fertilizer inside the collection straw as the plant fertilizer is received into and released from the collection straw.

5. The piston device of claim 4, wherein the individual windows represent graduated markings on an exterior of the cylinder.

6. The piston device of claim 1, wherein the scalloped edge is configured to cut through roots in the soil.

7. The piston device of claim 1, wherein the collection straw has a smooth bore shaft.

8. The piston device of claim 1, wherein the cylinder has an internal diameter which is larger than the outer diameter of the piston.

9. The piston device of claim 1, wherein the piston has an outer diameter which is less than the inner diameter of the cylinder.

10. The piston device of claim 1, wherein the piston is solid and the cylinder has a hollow interior.

11. The piston device of claim 1, further comprising a wooden handle portion mounted on a metal portion of the collection straw, wherein the cylinder is formed by both the wooden handle portion and the metal portion of the collection straw.

12. The piston device of claim 11, wherein the wooden handle portion is substantially cylindrical and has a flared end portion for gripping and pushing against between a user's fingers.

13. The piston device of claim 11, wherein the piston is a substantially solid wooden cylinder.

14. The piston device of claim 11, wherein the piston is has a wooden ball formed on an end of the piston.

15. A piston device, comprising:
a cylinder formed of a rolled up flat material; and
a piston configured to be pushed into a second end of the cylinder in an inserted configuration and withdrawn from the second end of the cylinder in an extended configuration, the piston slidable between the inserted configuration and the extended configuration during operation, wherein material is received into the cylinder through an opening in a first end of the cylinder, and wherein pressing the piston into the second end of the cylinder compresses the material within the cylinder, and then releases the material from the cylinder;
wherein the flat material of the cylinder has print thereon; and
wherein the piston has a conical shaped head.

16. The piston device of claim 15, wherein the flat material is a packaging material wrapped around the piston during transport and to form the cylinder.

17. The piston device of claim 16, wherein the packaging material is paper or cardboard.

18. The piston device of claim 15, wherein the piston is wood.

19. The piston device of claim 15, wherein the piston has an outer diameter which is less than the inner diameter of the cylinder.

20. The piston device of claim 15, wherein the piston is solid and the cylinder is formed by an end user to have a hollow interior from printed instructions for use of the piston device.
